(19) United States
(12) Patent Application Publication
(10) Pub. No.: US 2005/0014558 A1
(43) Pub. Date: Jan. 20, 2005

(54) Method for improving a player tracking system to provide players a recruiting incentive

(76) Inventor: Richard Craig Estey, Las Vegas, NV (US)

Correspondence Address: SHOOK, HARDY & BACON LLP, 2555 GRAND BLVD, KANSAS CITY,, MO, 64108, US

(21) Appl. No.: 10/620,411

(22) Filed: Jul. 16, 2003

(51) Int. Cl. A63F 13/00

(52) U.S. Cl. 463/29

(57) ABSTRACT

Disclosed is a method of operating a conventional gaming system. Such gaming systems typically have player tracking systems which have databases storing player profile fields for either a sponsoring player or a recruited player. The invented method works with a typical gaming system, but adds an additional field which stores the identity of the recruit's sponsor. Information regarding the recruit is then used to populate the recruit's profile with, among other things, information identifying the sponsor. Criteria are then set, which if met by the recruit, result in the recruit being accepted by the system. The sponsor and recruits gaming activity is then collected by the system into each player's profile, and ongoing, typically complementary, benefits are afforded to the sponsor based on the gaming activity of the recruit. Once the recruit is accepted into the system, he or she is able to become a sponsor with respect to new recruits.

### CROSS-REFERENCE TO RELATED APPLICATIONS

Not applicable

### STATEMENT REGARDING FEDERALLY SPONSORED RESEARCH OR DEVELOPMENT

Not applicable.

### TECHNICAL FIELD

The present invention relates to gaming and marketing and, more particularly, to a method for rewarding patrons of a gaming organization for recruiting new patrons to participate in the gaming offered by the gaming organization.

### BACKGROUND OF THE INVENTION

Casinos (as used, is intended to include all types of legalized gaming facilities and organizations) are a multi-billion dollar, world-wide industry. The odds of each game slightly favor the casino. Thus, over many bets, the casino wins and is profitable. This being well understood in the gaming industry, casinos attempt to attract and retain as many patrons as possible while encouraging these patrons to maximize their wagering activity.

Many casinos have implemented some form of customer tracking to identify and reward their valuable customers. These tracking programs often use the betting activity of a customer as the basis for awarding the customer complimentary rooms, meals, event tickets, cash and the like (“comps”).

For many years, casino employees visually observed customer's game play, manually tracking the gaming and wagering habits of the particular customers. The information gathered also allows the casinos to select certain customers to receive complimentary benefits and to determine the amount of comps a particular customer is to receive. The act of giving comps to a customer, commonly referred to as “comping,” produces a large amount of good will with the customers, encouraging customer loyalty and further wagering.

Some casinos have attempted to partially automate the player tracking process by installing computerized player tracking systems. Typically, these tracking programs are implemented by providing each customer with a casino membership card, which includes a machine readable identification number specific to the customer. Each identification number has an associated customer account that is stored in the casino's computer system and updated to reflect customer activity. The actual gaming and wagering patterns of the customers are visually observed by casino personnel and manually entered into a computer to create a digitized copy of the customer's gaming habits.

In more sophisticated systems, the gaming and wagering patterns of the customers are automatically recorded by the player tracking system. Customers need only insert their cards in slot machines or card readers associated with gaming tables or give their cards to a casino employee to have their betting or spending activity monitored and reflected in their accounts. Customer cards may also be used to track customer activity at casino venues, such as special events, showrooms, and hotels, through card readers and computer terminals manned by casino employees.

In the player tracking systems described, the cards used by casino customers serve the purpose of identifying the player and the player's account into which a plurality of data can be collected.

Typical and illustrative of such player tracking systems are those disclosed in U.S. Pat. Nos. 6,460,848, 5,429,361, and 5,761,647. In U.S. Pat. No. 6,460,848, Soltys et al. disclose a system that automatically monitors playing and wagering of a game, including the gaming habits of players and the performance of employees. The system disclosed provides automated security, real-time accounting, and a basis for automatically allocating complimentary player benefits.

In U.S. Pat. No. 5,429,361, Raven et al. teach an information and communication system that permits communication between gaming machines and a central control system and between a player or operator and a central control system. Raven's system provides many functions, including automated maintenance, game accounting, security, player tracking, event tracking, employee/player interaction from the game to the central data processor, cashless operation of gaming machines, and reserving gaming machines.

In U.S. Pat. No. 5,761,647, Boushy teaches a system and method for implementing a player tracking system and recognition program across many casino properties that encompasses gaming and non-gaming activity. Customers are awarded points, based on their tracked activity at all affiliated casino properties. The point awards have a monetary value and are redeemable for gifts, meals, cash and the like, at any of the casino properties. The point awards may embody different promotional schemes in which point awards are adjusted to target different casino properties or different venues within a casino.

In addressing a casino's desire to extend the duration of a patron's gambling session, Packes et al. disclose a method and apparatus for rewarding a player of a game based on the activity of other players (U.S. Pat. No. 6,319,122). In Packes, a server tracks each gaming session (i.e. the pull of a slot machine lever) and each outcome and ranks the sessions in order of time started. A player initiating a first gaming session is rewarded when a player from a subsequently initiated gaming session wins a jackpot of a predetermined amount. In an alternate embodiment, the player initiating a first gaming session receives a bonus, which is a small fraction of the total amount of money wagered by all of those gaming sessions begun after his session.

In some non-gaming industries, certain companies, like Amway for example, sell their goods through a multilevel marketing program. In the applicable portion of Amway's multilevel marketing programs, distributors periodically receive commissions both for the products they sell and for the sales by any distributors that they recruit. A commission is typically extended down to multiple levels of recruits, called a “down line.” A similar method, which describes the application of the multilevel marketing concept to a retail point-of-sale transaction, is taught by Masi et al. in U.S. Pat. No. 6,105,001. Masi's patent describes a system for promoting the use of a non-cash payment device, such as a debit card, wherein funds are transferred electronically for the purpose of providing commissions to a multilevel marketing organization. Neither the Amway marketing approach nor the Masi patent contemplate the application of such multilevel marketing approaches to gaming. The present invention's concept, benefiting existing players on a continuing basis when successful recruitment of additional players occurs, represents a new and unique concept in the gaming industry.

While much of the prior art attempts to create electronically various forms of player reward programs based on gaming activity, many of which stem from the manual practice of similar systems in the past, it would be advantageous if existing player tracking systems were extended to additionally reward players for the gaming activity of other players that were recruited either directly or indirectly by the first player. Such a system would be an effective marketing mechanism for the casino.

### SUMMARY OF THE INVENTION

The present invention solves at least the above problems by providing a method for improving a player tracking system to provide players an incentive to recruit new players. Offering several practical applications in the technical arts, the present invention enables members of a player tracking system to be rewarded for the gaming activity of their direct and indirect recruits. As a result of providing these rewards, the, present invention promotes customer loyalty, a larger customer base, and more gaming activity.

The present invention also includes a method for improving a player tracking system to provide players a recruiting incentive. At least one additional field is added to each player profile in the player tracking system database for storing information identifying a player's sponsoring member. Information is stored in a player profile related to a recruited member, including information identifying a sponsoring member. Assuming a recruit is a qualified to become a member, he is accepted into the player tracking system. The gaming activities of the new member are tracked and recorded by the player tracking system. Then, complimentary benefits are offered to a new member's sponsoring member based on the gaming activity of the new member.

The present invention also includes a method for providing a reward program for recruiting and retaining gaming patrons. The reward program uses a player tracking system to monitor and record player gaming activity. A database is maintained within the player tracking system for storing patron information, including information identifying the direct recruiter of a patron and recorded gaming activity. Incentives are offered to a patron's direct recruiter based on the gaming activity of the patron.

### BRIEF DESCRIPTION OF THE SEVERAL VIEWS OF THE DRAWINGS

The present invention is described in detail below with reference to the attached drawing figures, wherein:

FIG. 1 is a block diagram of a central database server of a conventional player tracking system suitable for implementing the present invention;

FIG. 2 is an overall block diagram of a conventional player tracking system suitable for implementing the present invention;

FIG. 3A is a flow chart that illustrates a method for offering incentives to members of a player tracking system for recruiting new members;

FIG. 3B is a continuation of FIG. 3A;

FIG. 4 is a pictorial depiction of a sponsoring hierarchy;

FIG. 5 is a summary of the recorded gaming activity for PTS member #05 and recruits; and

FIG. 6 is an another embodiment of the summary of the recorded gaming activity for PTS member #05 and recruits.

### DETAILED DESCRIPTION OF THE INVENTION

The present invention provides a new and useful method for improving a player tracking system to provide players a recruiting incentive. To this end, members of a player tracking system are rewarded based on the gaming activity of their direct and indirect recruits. Gaming organizations, such as casinos, need new ways to attract and maintain a large customer base. The present invention offers a gaming institution a marketing tool with known costs. Unlike more common marketing approaches such as television advertising or billboards, the costs associated with recruiting a new patron using the present invention are incurred after a new patron engages in gaming activity. Those of ordinary skill in the art of player tracking systems will be able to make and use the invention according to the disclosure hereof.

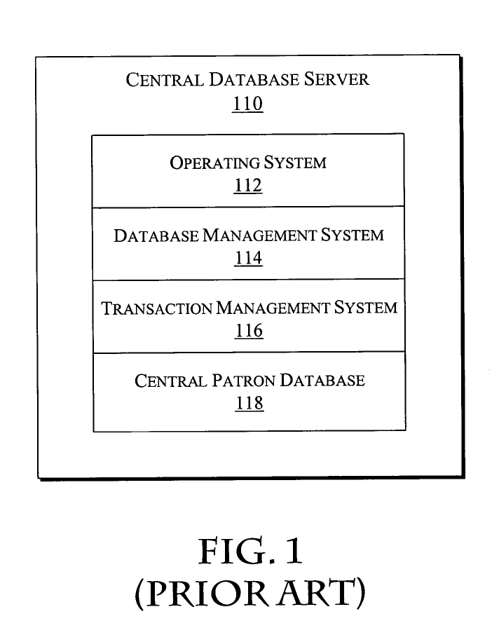

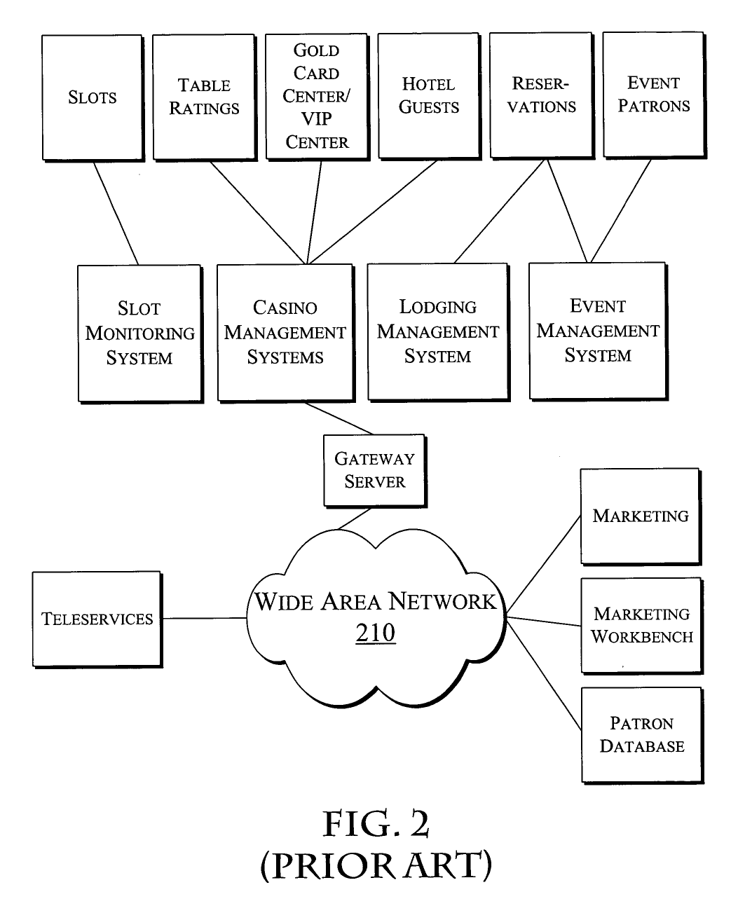

The present invention may be implemented in conjunction with a player tracking system such as disclosed by Boushy in U.S. Pat. No. 5,761,647, herein incorporated by reference, and shown in FIGS. 1-2. Briefly described, the Boushy player tracking system can be implemented on a Wide Area Network (WAN) 210 as shown in FIG. 2 for tracking and recording player gaming activities across many associated gaming facilities and affiliated organizations. An element of Boushy's patent is the central database server 110 which comprises various systems including an Operating System (OS) 112, a database management system (DBMS) 114, a transaction management system 116, and a central patron database (CPDB) 118. Transaction management system 116 supports messaging between casino Local Area Networks (LANS) and services on central WAN 210, allowing them to exchange data as necessary. In the disclosed embodiment, central database server 110 is an NCR 3555 computer, OS 112 is Unix SVR4, DBMS 114 is Informix 7.1, and transaction management system 116 is TOP END, available from AT&T/NCR.

The player tracking system disclosed by Boushy is meant to be illustrative in nature and in no way limiting. Further, any system in the gaming industry, manual or automatic, for tracking player activity could be adapted by one skilled in the relevant art to implement the present invention.

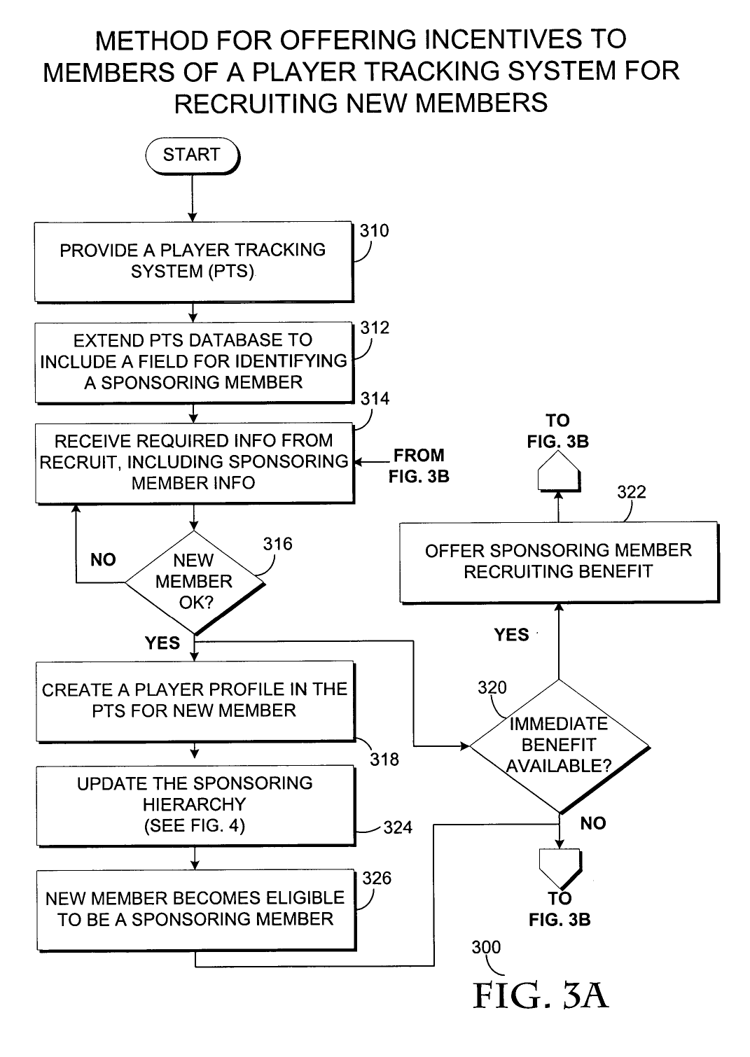

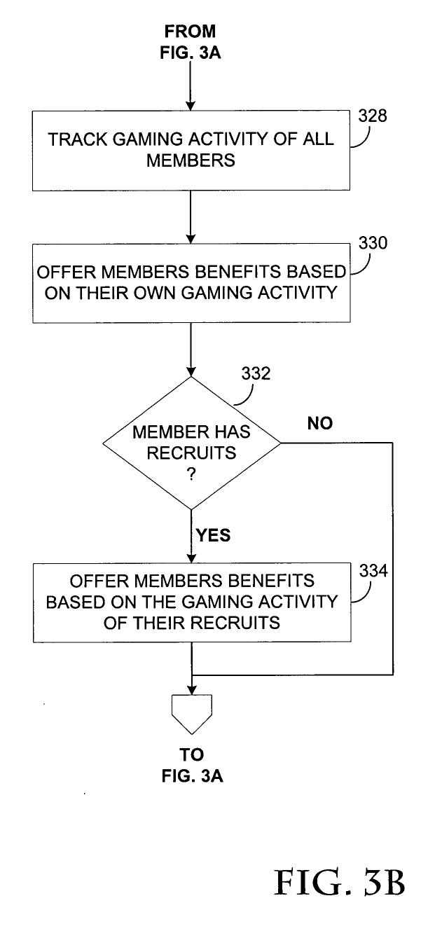

A method for offering incentives to members of a player tracking system for recruiting new members is depicted in the flow charts of FIGS. 3A and 3B. Beginning at Step 310, a player tracking system (PTS), such as one similar to that described above, is provided by a casino or other gaming organization. In step 312, the PTS database that contains player profiles (also called member profiles) requires additional programming. Extra fields are added to the player profiles, including a field identifying a sponsoring member. The sponsoring member field will be used to form a sponsoring hierarchy 400, which associates members with the various levels of their direct and indirect recruits. Sponsoring hierarchy 400 is more fully described below. One skilled in the relevant art will appreciate that there are many ways to extend and structure the PTS database to accommodate the additional fields used by the present invention.

A player tracking system member's direct recruit is an individual who is recruited by the member to also become a member of the player tracking system. A player-tracking-system member's indirect recruit is an individual who is recruited by a direct recruit of the member of a player tracking system. Individuals recruited by a player-tracking-system member's indirect recruits are also considered the member's indirect recruits.

In Step 314, a recruit's personal information necessary for accepting a new member into the PTS is received by the gaming organization. This can be accomplished in many ways. A recruit can interact with gaming organization staff and the staff manually enters the information. The information could be entered at an unmanned kiosk via a computer system. The information could be accepted over the Internet or by many other communication methods. This recruit information can contain information identifying a sponsoring member. A sponsoring member is a current member of the PTS who has recruited the individual applying for PTS membership.

In Step 316, the PTS or gaming organization staff may evaluate the received information for the purpose of accepting the applicant as a new member. As one skilled in the relevant art would appreciate, a program for applying acceptance criteria can be implemented in a PTS in many fashions and specific criteria will vary greatly based on the needs of individual gaming establishments. Examples of some criteria that a gaming organization might require include ensuring that the sponsoring member is a member in good standing, the new recruit has not been previously “black-listed” from the gaming organization or its affiliates, the new recruit has no criminal record prohibiting him from participation in wagering events, adequate information has been provided for reporting significant winnings to the appropriate taxing authority, and the like.

If, in STEP 316, the information provided is incomplete or the applicant is rejected, the method returns to Step 314 and collects more information or ends. If the information provided is adequate and the applicant meets any criteria for acceptance into the PTS, the method proceeds in parallel to both Step 318 and Step 320.

In Step 318, the PTS creates a new player profile in the database that stores the player profiles and populates the new player profile with the information collected in Step 314. At this point, the applicant has been accepted as a new member.

In one embodiment of the invention, a sponsoring member is offered an incentive immediately upon the acceptance of a directly recruited member into the PTS. In Steps 320 and 322, eligible sponsoring members are identified and their player profiles are updated with the appropriate rewards. For instance, in one embodiment, a cash reward is offered to the sponsoring member. In another embodiment, a sponsoring member's player profile is updated to include additional reward points redeemable for merchandise, food, special events, and the like.

In Step 324, sponsoring hierarchy 400 is updated to reflect the addition of the new member into the PTS. As one skilled in the art can appreciate hierarchical parent-child relationship structures are well understood and can be implemented in many ways within the PTS. At this point, Step 326, the new member has been fully added into the recruiting incentive program and can be eligible to also recruit new members. Some gaming organizations may require new members to meet other criteria before being eligible to recruit new members. Such criteria may include a waiting period, participating in a certain amount or variety of gaming activity, and the like.

A method for accepting a new recruit into the PTS, identifying a sponsoring member, and immediately rewarding said sponsoring member has thus been disclosed.

Referring now to FIG. 3B, the remaining steps of offering incentives to members of a PTS for recruiting new members based on the gaming activity of the recruited members are described. In Step 328, the PTS continues to track the gaming and other activity of all members of the PTS. All member's various activities, including monies spent and monies wagered on various types of gaming are stored in their player profile.

In Step 330, rewards, such as cash or complimentary benefits, can be offered to members based on their own gaming activity. The present invention may be configurable to calculate gaming activity based on the value of all wagers placed by a player, the value of all winnings associated with all wagers placed by a player, or a combination of both. In this regard, the value of a player's net winnings could also be given consideration in the calculation of gaming activity. For instance, a player may be offered a cash reward equal to a percentage of his total wagering activity or other activity, such as shopping, eating, drinking, staying at a casino hotel, and the like. In another embodiment, a member's player profile is updated to reflect additional reward points that are redeemable for merchandise, food, special events, and the like. Some gaming organizations may wish to eliminate step 330.

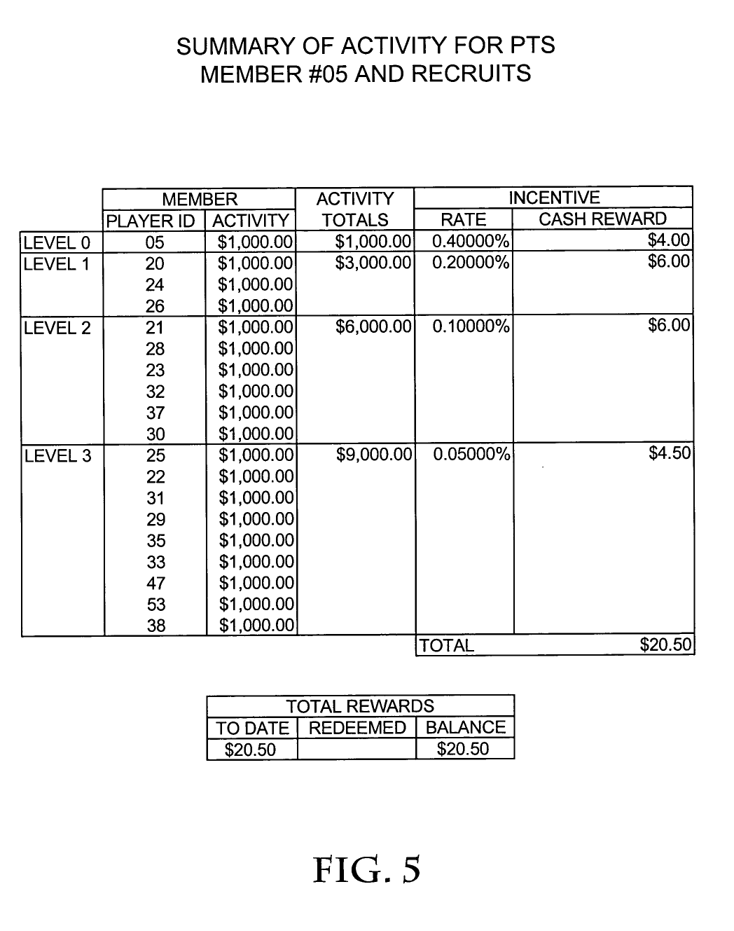

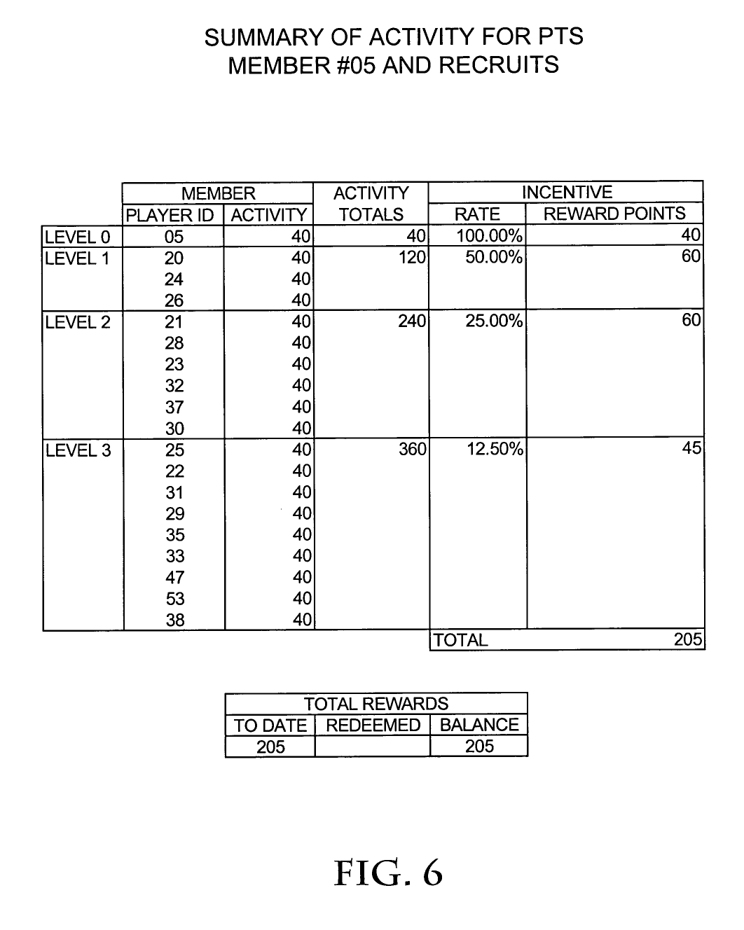

A member can also be rewarded for the activities of their direct and indirect recruits. Step 332 checks to see if a member has sponsored any direct or indirect recruits. The PTS can access sponsoring hierarchy 400 to accomplish this task, or, as one skilled in the relevant art could appreciate, there are a number of ways to access the PTS database and determine the players that were directly and indirectly recruited by a member. If a member has recruited other players, they are eligible for additional incentives based on the wagering activities of their direct and indirect recruits. Some specific incentive schemes are detailed below and are represented in FIGS. 5 and 6.

The above described method for offering rewards to members of a PTS who recruit new members is an automatic, continuous and self-updating process that returns to step 314 in anticipation of accepting new members into the rewards program.

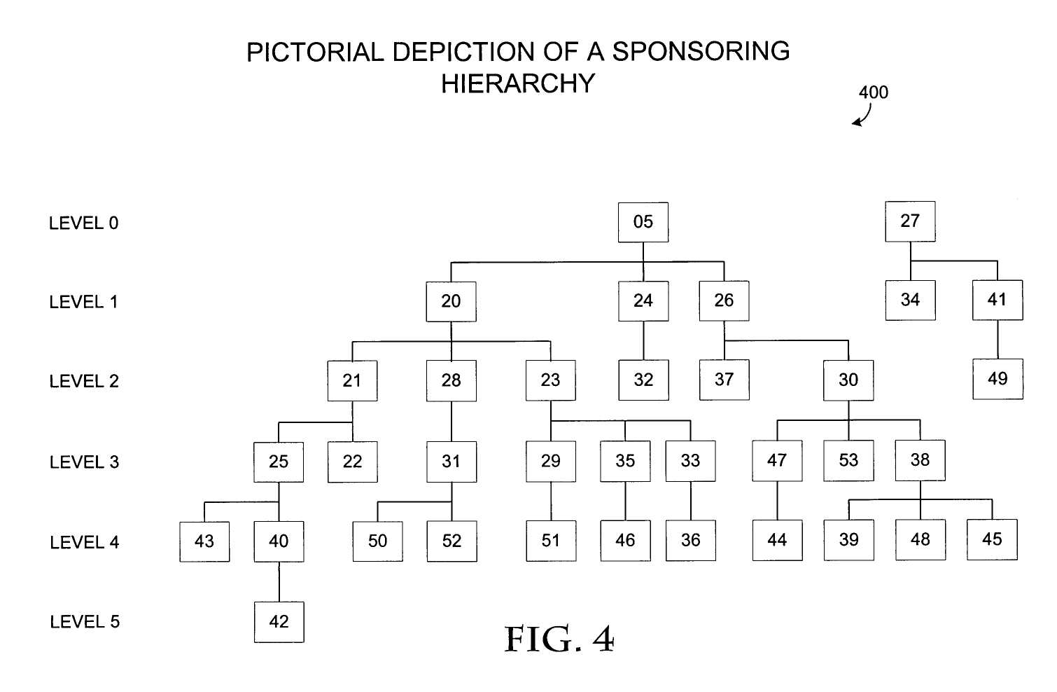

Referring now to FIG. 4, a pictorial depiction of sponsoring hierarchy 400 is presented. In the sponsoring hierarchy 400, players #05 and #27 have been arbitrarily selected for illustrative purposes and are shown at the top level, which is referred to as Level 0. The level indicators apply individually to each member. For instance, player #21 is a direct recruit of player #20. Thus, player #21 's gaming activity is considered Level 0 activity for himself, Level 1 activity with respect to player #20, and Level 2 activity with respect to player #05 (which is shown in the player #05 -centric sponsoring hierarchy of FIG. 4). Thus, every player's own gaming activity is associated with Level 0. As shown, the sponsoring hierarchy of FIG. 4 depicts players #05 and #27, their direct recruits, and their indirect recruits. However, the hierarchy could be redrawn to show the sponsoring relationship between other members of the PTS.

As shown, player #05 has three direct recruits, player #20, player #24, and player #26. Players #20, #24, and #26 are Level 1 direct recruits of player #05. Player has two direct recruits, player #37 and player #30. Players #37 and #30 are Level 1 direct recruits of player #26. Players #37 and #30 are Level 2 indirect recruits of player #05, and so on.

As an example, Table 1 below, summarizes the sponsoring hierarchies of player #05 and player #27. The table also assumes, for example purposes, $1,000 of gambling activity associated with players #05 and #27 and their subordinate levels, which are comprised of direct and indirect recruits.

TABLE 1
Summary of player activity

| | | | Player | |
|---|---|---|---|---|
| Position in | Player | Total | ID | Total |
| Hierarchy | ID Numbers | Activity | Numbers | Activity |
| Level 0 | 05 | $1,000 | 27 | $1,000 |
| Level 1 | 20, 24, 26 | $3,000 | 34, 41 | $2,000 |
| Level 2 | 21, 28, 23, 32, 37, 30 | $6,000 | 49 | $1,000 |
| Level 3 | 25, 22, 31, 29, 35, 33, 47, | $9,000 | | |
| | 53, 38 | | | |
| Level 4 | 43, 40, 50, 52, 51, 46, 36, | $11,000 | | |
| | 44, 39, 48, 45 | | | |
| Level 5 | 42 | $1,000 | | |

From FIG. 4, it can be seen that the hierarchy of members is established much like an organizational chart of a business, where new members (like employees) are linked directly subordinate to the member who recruited them (like the supervisor of an employee). Those skilled in the relevant art will recognize that modern databases can be programmed to continuously track the hierarchical relationships between players when provided with the data indicating who recruited each player.

In one embodiment, authorized operators of the system can administratively configure the present invention to establish the characteristics or parameters of the incentive program. These parameters include the base, Level 0, reward rate for each type of qualified activity, the number of subordinate levels eligible for rewards, and the absolute or relative rate of reward for each eligible subordinate level. Various qualified activities may be associated with different reward rates. For example, video poker may earn less reward than slot machine play due to the higher payback typically offered on video poker. Also, merchandise shopping may reward at a different rate than restaurant patronage.

Furthering the example provided in Table 1, a gaming organization determines that they will return up to 0.75% of the gross revenue generated by a sponsoring member and their direct and indirect recruits to the sponsoring member. In one embodiment of the present invention, the authorized staff could configure the present invention as follows:
a. 0.4% base reward rate for all qualified activities (reported as cash or points, or the like. For example, this may be 1 point for every $25 of qualified activity and $1 of redemption value for every 10 point accumulated. This is the equivalent of awarding $1 for every $250 of qualified activity or 0.4%)
b. 3 subordinate levels in the sponsoring hierarchy eligible for rewards

$$\begin{matrix}\begin{matrix}c . Level 1 reward = \frac{base reward}{2} = 0.2 \% \\ d . Level 2 reward = \frac{Level 1 reward}{2} = 0.1 \% \end{matrix} \\ e . Level 3 reward = \frac{Level 2 reward}{2} = 0.05 \%\end{matrix}$$

With the sponsoring hierarchy shown in FIG. 4, two additional embodiments of the present invention are now disclosed in FIGS. 5 & 6. FIG. 5 depicts a summary of qualified activity for player #05 and player #05 's direct and indirect recruits, which is stored in a member's player profile. FIG. 5 also represents an embodiment of Steps 330, 332, and 334, as described above, in that a member is offered an incentive for their recruiting efforts by offering a cash reward based on the gaming activity of direct and indirect recruits. Other activities and monies spent by recruits could also be eligible activity for rewards. As shown in FIG. 5, player #5 is rewarded with $4.00 for his own gaming activity, $6.00 for the gaming activity of his direct, Level 1 recruits $6.00 for the gaming activity of his indirect, level 2 recruits, and $4.50 for the gaming activity of his indirect, Level 3 recruit. The invention allows for the depth of recruits within a member's sponsoring hierarchy who's gaming activity is eligible for rewards to be arbitrarily chosen by a gaming organization. Likewise, the size of the reward associated with each level can be arbitrarily chosen.

The invention contemplates many different methods and functions for selecting rewards. In an alternative embodiment, as shown in FIG. 6, player #05 is awarded Reward Points that are redeemable for merchandise, food, special events, and the like. As shown, the reward rate is 1 point for every $25 of tracked activity. The redemption value of the points can be arbitrarily set by individual gaming organizations. As an example, for the same benefit realized in FIG. 5, the redemption value of the Reward Points would be set at $1 per 10 points. FIGS. 5 & 6 demonstrate that a plurality of methods are available for calculating, recording, and presenting member rewards.

In another embodiment, authorized operators of the system can administratively configure the present invention to further establish the characteristics or parameters of the incentive program to rank members based on predetermined criteria and promote qualified members into tiers that earn higher rewards. Table 2 below illustrates this embodiment. The tier qualification criteria can include the qualified activity of each member's subordinate levels. Tier rewards can include increased rewards for personal and subordinate qualified activity and increasing the number of subordinate levels eligible for rewards.

TABLE 2
Tier rewards

| | Tier 1 | Tier 2 | Tier 3 |
|---|---|---|---|
| Base tracked activity | $25 per point | $25 per point | $20 per point |
| per point | | | |
| # subordinate levels | 3 | 4 | 4 |
| eligible for reward | | | |
| Level 0 reward rate | 100% Base | 100% Base | 100% Base |
| Level 1 reward rate | 50% Base | 50% Base | 50% Base |
| Level 2 reward rate | 25% Base | 25% Base | 25% Base |
| Level 3 reward rate | 12.5% Base | 12.5% Base | 12.5% Base |
| Level 4 reward rate | N/A | 6.25% Base | 6.25% Base |
| Redemption value | 10 points per dollar | 10 points | 10 points |
| | | per dollar | per dollar |
| Total incentive for a | 0.75% | 0.775% | 0.96875% |
| member | | | |

For example, a member's tier status could be associated with the number of total reward points accumulated to date or accumulated the previous year, and the tier criteria could be:
Tier 1: 0 to 4999 points
Tier 2: 5000 to 19,999 points
Tier 3: over 20,000 points

Thus an additional aspect of the present invention has been disclosed that enables a gaming organization to offer additional recruiting incentives to members that have been particularly effective recruiters.

As can be seen, the present invention and its equivalents are well adapted to provide a new and useful method for improving a player tracking system to provide players a recruiting incentive. Many different arrangements of the various components and steps depicted, as well as components and steps not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled artisan may develop alternative systems or methods while maintaining one of the several objectives of the invention, which are not limited to rewarding members of a gaming organization for the gaming activity of their direct and indirect recruits, improving a player tracking system to provide players a recruiting incentive, and disclosing a new reward program for recruiting and retaining gaming patrons.

It will be understood that certain features and subcombinations are of utility and may be employed without reference to other features and subcombinations and are contemplated within the scope of the claims. Not all steps listed in the various figures need be carried out in the specific order described.

1. A method of operating a gaming system, the gaming system comprising a player tracking system (PT-S) having a PTS database capable of storing player profile fields therein, said player being tracked by said PTS being either a sponsoring player or a recruited player, said method comprising:
creating at least one additional field for each player profile to store information identifying a recruited player's sponsoring player;
receiving information relating to the recruited player for the purpose of populating the recruited player profile and wherein said received information includes information identifying a sponsoring player;
establishing recruited player criteria;
accepting a recruited player into the PTS that meets the recruited player criteria;
populating and storing a player profile in said PTS database corresponding to said received information from said recruited player;
recording each player's gaming activity collected by said PTS database in each player's profile; and
offering ongoing, typically complimentary, benefits to the recruited player's sponsoring player based on the gaming activity of said recruited player;

2. The method of claim 1, wherein manual bookkeeping and player tracking replaces said PTS.

3. The method of claim 1, further comprising allowing a new player, subsequent to acceptance into said PTS, to become a sponsoring member.

4. The method of claim 3, further establishing a sponsoring hierarchy for recording the hierarchical relationship between sponsoring members and their sponsored players, wherein said hierarchical relationship would contain many levels of direct and indirectly sponsored players.

5. The method of claim 4, further comprising offering complimentary benefits to a first player based on the gaming activity or other qualified activity of subsequent players directly and indirectly sponsored by said first player as recorded in said sponsoring hierarchy.

6. The method of claim 5, wherein said offered complimentary benefits based on said sponsoring hierarchy are based on a selectable number of levels in said sponsoring hierarchy.

7. The method of claim 5, wherein said offered complimentary benefits are independently selectable for each level of an individual member's sponsored hierarchy.

8. The method of claim 5, wherein said offered complimentary benefits for each level of an individual member's sponsored hierarchy are selectable and based on a mathematical formula.

9. The method of claim 5, wherein said offered complimentary benefits for each level of an individual member's sponsored hierarchy are selectable and based on the nature of the qualified activity.

10. The method of claim 5, further comprising offering an immediate incentive to said sponsoring member of a new player upon acceptance of said new player into said PTS.

11. The method of claim 5, wherein qualified gaming activity is based on at least one of the following: the sum of all wagers placed by a player, the sum of all winnings associated with all wagers placed by a player, a configurable combination of a player's wagers and winnings, the net winnings associated with a player, and other qualified spending by a player.

12. The method of claim 5, wherein said offered complimentary benefits are associated with qualified activity participated in by direct and indirect recruits beyond a minimum wagering volume, wherein a recruit's gaming activity volume is a running sum of the value of all qualified gaming activity.

13. The method of claim 12, wherein said accumulated gaming activity volume is periodically set to zero.

14. The method of claim 10, further comprising populating the sponsoring member field of an existing member's player profile with information identifying a sponsoring member.

15. The method of claim 14, further comprising allowing a member of said PTS to change his sponsoring member to identify a different member of said PTS.

16. The method of claim 15, further comprising requiring permission from said first sponsoring member before said change is enacted.

17. The method of claim 16, wherein the method described operates in the environment of a single casino.

18. The method of claim 16, wherein the method described is extended to accommodate multiple locations of a gaming organization.

19. The method of claim 16, wherein the method described is extended to accommodate multiple locations of organizations affiliated with a gaming organization.

20. The method of claim 18, wherein a gaming organization includes a casino, a race track, a dog racing track, a horse racing track, a sports betting organization, a bingo hall, and a lottery as well as a bar, a retail store, and other facilities where legalized gaming is permitted.
